(19) United States
(12) Patent Application Publication
(10) Pub. No.: US 2014/0312146 A1
(43) Pub. Date: Oct. 23, 2014

(54) SPRAY GUN STRUCTURE FOR USE BY A LEFT-HANDED PERSON

(71) Applicant: TIAO-HSIANG HUANG, TAIPEI CITY (TW)

(72) Inventor: TIAO-HSIANG HUANG, TAIPEI CITY (TW)

(21) Appl. No.: 14/191,702

(22) Filed: Feb. 27, 2014

(30) Foreign Application Priority Data
Apr. 22, 2013 (TW) 102207320

(51) Int. Cl. B05B 7/04

(52) U.S. Cl. CPC B05B 7/0408
USPC 239/526

(57) ABSTRACT

A spray gun structure for use by a left-handed person is provided. When held in the left hand, the spray gun structure defines a positive direction, which is the direction the palm of the left hand faces, and a negative direction, which is opposite to the positive direction. The spray gun structure includes a nozzle, a handle, and a body connecting the nozzle and the handle. The body is provided with a regulating knob projecting in the positive direction. The spray gun structure is further provided with a paint can connecting portion extending in the negative direction. When the handle of the spray gun structure is held in the left hand, the regulating knob, which is provided on the body and projects in the positive direction, can be rotated directly by the thumb of the left hand to enable single-handed operation and ease of use.

### BACKGROUND OF THE INVENTION

1. Technical Field

The present invention relates to a spray gun structure for use by a left-handed person. More particularly, the present invention relates to a spray gun structure configured for single-handed use and having a regulating knob whose location facilitates operation by a left-handed user.

2. Description of Related Art

Spray guns are well known in the art. For example, Taiwan Utility Model Patent No. M319087 discloses “Spray Gun with a Paint Can to Be Fixed at Multiple Angles”, whose main structure includes a spray gun and a paint can fixedly provided at an appropriate position on the spray gun. A user can fill the paint can with a spray paint and, when it is desired to do spray painting, allow the spray paint to enter the spray gun in order to be sprayed.

To enable single-handed operation, the spray gun is laterally provided with a regulating knob whose location, however, is beneficial only to right-handed users and is bound to cause inconvenience to the left-handed. Moreover, as the paint can is provided above the spray gun, the user's view is very likely to be blocked by the paint can when the spray gun is in use. Consequently, the user may have problem seeing how the spray paint is applied.

U.S. Design Pat. No. D548816, titled “Paint Spray Gun”, discloses a spray gun having regulating knobs on both lateral sides so that left-handed as well as right-handed users can use the spray gun with ease. However, with the paint can provided above the spray gun, the user's view may still be obstructed by the paint can when the spray gun is in use.

### BRIEF SUMMARY OF THE INVENTION

In view of the needs of left-handed users, the inventor of the present invention conducted extensive research and finally succeeded in developing a spray gun structure for use by a left-handed person. The spray gun structure disclosed herein is designed to be held with the left hand and defines, when thus held, a positive direction, which is the direction the palm of the left hand faces, and a negative direction, which is opposite to the positive direction. The spray gun structure includes a nozzle, a handle, and a body connecting the nozzle and the handle. The body is provided with a regulating knob projecting in the positive direction. The spray gun structure is also provided with a paint can connecting portion extending in the negative direction.

The present invention has the following advantageous effects:

1. When the handle of the spray gun structure is held in the left hand, the regulating knob, which is located on the body and projects in the positive direction (i.e., the direction the palm of the left hand faces), can be rotated directly by the thumb of the left hand to enable single-handed operation and enhance the convenience of use by a left-handed person.

2. As the paint can connecting portion of the present invention extends in the negative direction (i.e., the direction opposite to the direction the palm of the left hand faces), the paint can will not interfere with a left-handed user's view during paint application. As such, the present invention features increased utility.

### BRIEF DESCRIPTION OF THE SEVERAL VIEWS OF THE DRAWINGS

FIG. 1 is a perspective view of a preferred embodiment of the present invention;

FIG. 2 is a side view showing the preferred embodiment of the present invention in use; and

FIG. 3 is a top view of the preferred embodiment of the present invention.

### DETAILED DESCRIPTION OF THE INVENTION

The technical features and major effects of the spray gun structure of the present invention are now demonstrated by the following embodiment.

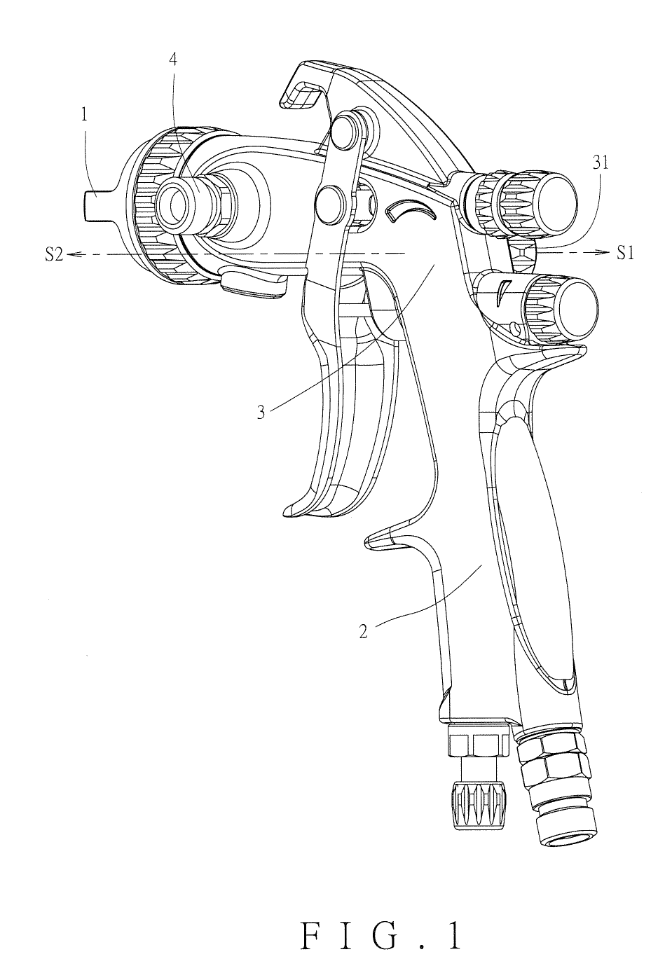

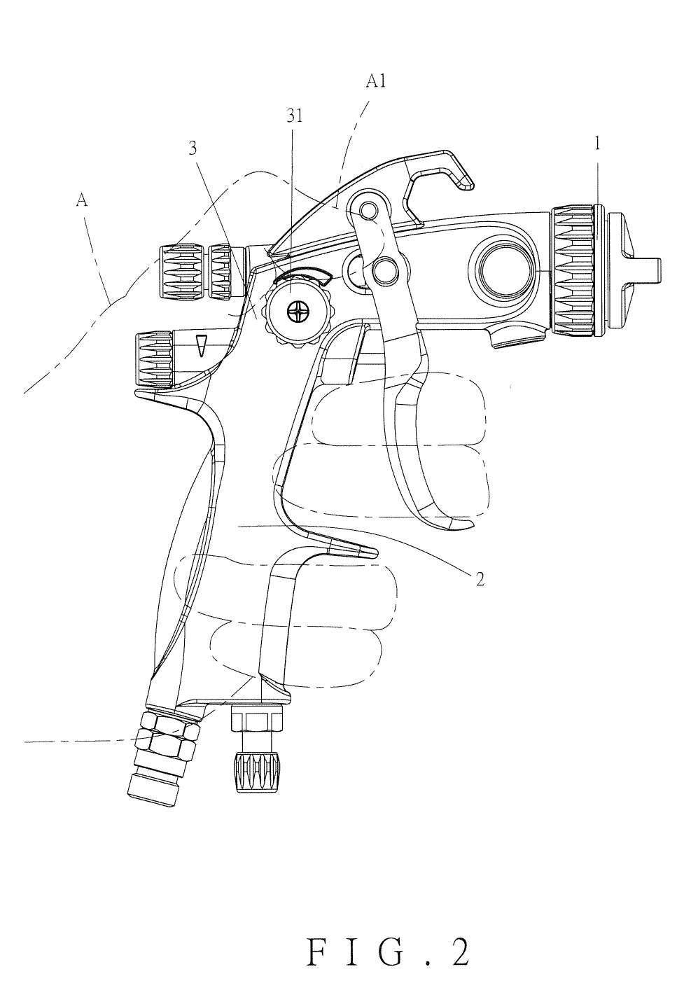

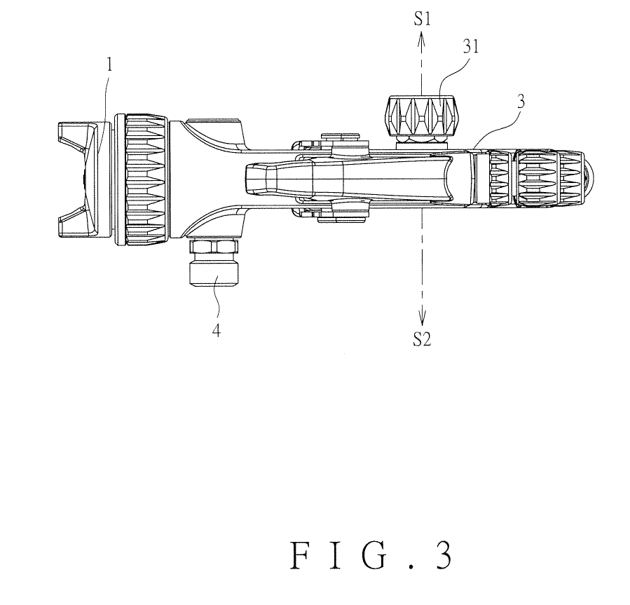

Referring to FIG. 1 to FIG. 3, a preferred embodiment of the present invention includes a nozzle 1, a handle 2, and a body 3 which connects the nozzle 1 and the handle 2. The body 3 has a positive direction S1 and an opposite negative direction S2, wherein the positive direction S1 is defined as the direction that the palm of the user's left hand A faces when the handle 2 is held in the left hand A. The body 3 is provided with a regulating knob 31 which projects in the positive direction S1. The spray gun structure is also provided with a paint can connecting portion 4 which extends in the negative direction S2.

When the user holds the handle 2 with the left hand A, the regulating knob 31 on the body 3 projects in the direction the palm of the left hand A faces (i.e., the positive direction S1). Therefore, the user can rotate the regulating knob 31 directly with the thumb A1 of the left hand A, and the purpose of single-handed operation is achieved, making the present invention convenient to use by a left-handed person. Furthermore, as the paint can connecting portion 4 extends in the direction opposite to the direction the palm of the left hand A faces (i.e., in the negative direction S2), the paint can will not keep a left-handed user from seeing how the paint is sprayed. Thus, the utility of the present invention is increased.

While the foregoing embodiment is described as being used by a left-handed person to demonstrate the fact that the present invention is especially suitable for left-handed users, it does not imply that the spray gun structure of the present invention cannot be held and used by a right-handed person.

The operation and intended effects of the present invention have been fully disclosed by the embodiment given above. The embodiment, however, is only one preferred embodiment of the present invention and should not be construed as restrictive of the scope of the present invention. All equivalent changes and modifications which are based on the above description and the appended claim and which are easily conceivable by a person skilled in the art should fall within the scope of the present invention.

What is claimed is:

1. A spray gun structure for use by a left-handed person, the spray gun structure being configured to be held with a left hand and when thus held define a positive direction and a negative direction, the positive direction being a direction the palm of the left hand faces, the negative direction being a direction opposite to the positive direction, the spray gun structure comprising:
a nozzle, a handle, and a body connecting the nozzle and the handle, the body being provided with a regulating knob projecting in the positive direction, the spray gun structure being further provided with a paint can connecting portion extending in the negative direction.
